(19) United States
(12) Patent Application Publication
(10) Pub. No.: US 2007/0201605 A1
(43) Pub. Date: Aug. 30, 2007

(54) NATURAL CIRCULATION BOILING WATER REACTOR

(76) Inventors: Kazuya ISHII, Hitachi (JP); Motoo AOYAMA, Mito (JP); Tetsushi HINO, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/680,098

(22) Filed: Feb. 28, 2007

(30) Foreign Application Priority Data
Feb. 28, 2006 (JP) 2006-053088

(51) Int. Cl. G21C 1/04

(52) U.S. Cl. 376/352

(57) ABSTRACT

A core disposed in a reactor pressure vessel includes one layer (an outermost region) at an outermost side of the core, two-three layers (an outer region) inside the outermost region and other layers (an inner region) inside the outer region. Fuel assemblies arranged in the core are supported by fuel supports having orifice. Orifice pressure loss coefficient of the orifice in the outermost region is set to be maximum and the orifice pressure loss coefficient of the orifice in the outer region is set to be minimum such that the flow rate of the coolant W for each fuel assembly in the outermost region is lowest and that for each fuel assembly in the outer region is highest. In the core of the natural circulation boiling water reactor, the reactor power distribution in a radial direction is flattened, and it is possible to increase the thermal margin.

### CLAIM OF PRIORITY

The present application claims priority from Japanese application serial no. 2006-053088, filed on Feb. 28, 2006, the content of which is hereby incorporated by reference into this application.

### BACKGROUND OF THE INVENTION

The present invention relates to a natural circulation boiling water reactor.

In a forced circulation boiling water reactor, core flow rate of the coolant for cooling fuel assemblies loaded in a core is determined by output of a pump. The flow rate distribution to each fuel assembly is set by pressure loss coefficient of the orifice provided so as to correspond to each fuel assembly. Technology has been disclosed in which setting of the orifice pressure loss coefficient for the fuel assemblies, for example, may be such that the orifice pressure loss coefficient is larger in the outermost region of the core than the inner region near the center of the core, and thus the coolant flow rate distribution to the each fuel assembly is optimized by being small in the outermost region and large in the inner region, thereby increasing the thermal margin (see Japanese Patent Laid-open No. Hei 7-181280).

On the other hand, in the natural circulation boiling water reactor, the core flow rate of the coolant is determined as the sum of the flow rate due to natural circulation flow in the individual fuel assemblies. That is to say, the flow rate of the coolant in the individual fuel assemblies does not affect the flow rate of the coolant in the other fuel assemblies. As a result, as in the case of the forced circulation boiling water reactor, even if the orifice diameter is set to reduce the flow rate of the coolant in the outermost region, the flow rate of the coolant in the inner region remains constants and does not increase and there is no effect on the increase in the thermal margin. Thus, the natural circulation boiling water reactor has received much attention with focus being placed on the power characteristics of the fuel assemblies. In Japanese Patent Laid-open No. Hei 1-176991, technology has been disclosed in which by setting the orifice pressure loss coefficient of the fuel assembly to be smaller in the outermost region than that in the inner region, the coolant flow rate to the outermost region is increased and the power of the outermost region is increased.

### SUMMARY OF THE INVENTION

According to the prior art technology for the natural circulation boiling water reactor, by increasing the coolant flow rate to the outermost region, there is the effect that the power of the fuel assemblies at the outermost region is increased and the power distribution in a radial direction of the core is flattened. However, on the other hand, there are problems in that the thermal margin in the core is reduced due to the increase in the temperature of the coolant that re-circulates in the core, and the reactivity of the core is reduced.

The object of the present invention is to provide a natural circulation boiling water reactor in which the power distribution in a radial direction of the core is flattened, and in which it is possible to increase the thermal margin.

The present invention for attaining the above object is a natural circulation boiling water reactor in which a core includes a plurality of regions having a plurality of fuel assemblies, disposed in a radial direction respectively, and the flow rate of the coolant is set to be high in the region which is close to the outer periphery, in which the effect on core reactivity is high, of the core, and the flow rate of the coolant is set to be low to the region in which the effect on core reactivity is low.

According to the present invention, the coolant flow rate distribution to each fuel assembly arranged in the core, and thus power distribution in a radial direction of the core is flattened and it becomes possible to increase the thermal margin.

### BRIEF DESCRIPTION OF THE DRAWINGS

FIG. 1 is a structural view showing a natural circulation boiling water reactor according to an embodiment of the present invention.

FIG. 2A is a longitudinal sectional view of a fuel assembly.

FIG. 2B is a plane view of a fuel assembly shown in FIG. 2A.

FIG. 3A is a structural view showing a fuel support disposed in an inner region of a core.

FIG. 3B is a structural view showing another fuel support disposed in an outermost region of a core.

FIG. 4 is a sectional view taken along a line X-X of FIG. 1.

FIG. 5 is a cross sectional view showing a ¼ division region of a core according to first embodiment of the present invention.

FIG. 6 is a cross sectional view showing a ¼ division region of a core according to second embodiment of the present invention.

FIG. 7 is a cross sectional view showing a ¼ division region of a core according to third embodiment of the present invention.

FIG. 8 is a cross sectional view showing a ¼ division region of a core according to the fourth embodiment of the present invention.

FIG. 9 is a cross sectional view showing a ¼ division region of a core according to fifth embodiment of the present invention.

FIG. 10 is a cross sectional view showing a ¼ division region of a core according to sixth embodiment of the present invention.

FIG. 11 is a cross sectional view showing a ¼ division region of a core according to seventh embodiment of the present invention.

### DESCRIPTION OF THE PREFERRED EMBODIMENT

The following is a detailed description of the preferred embodiments of the present invention using the appropriate drawings.

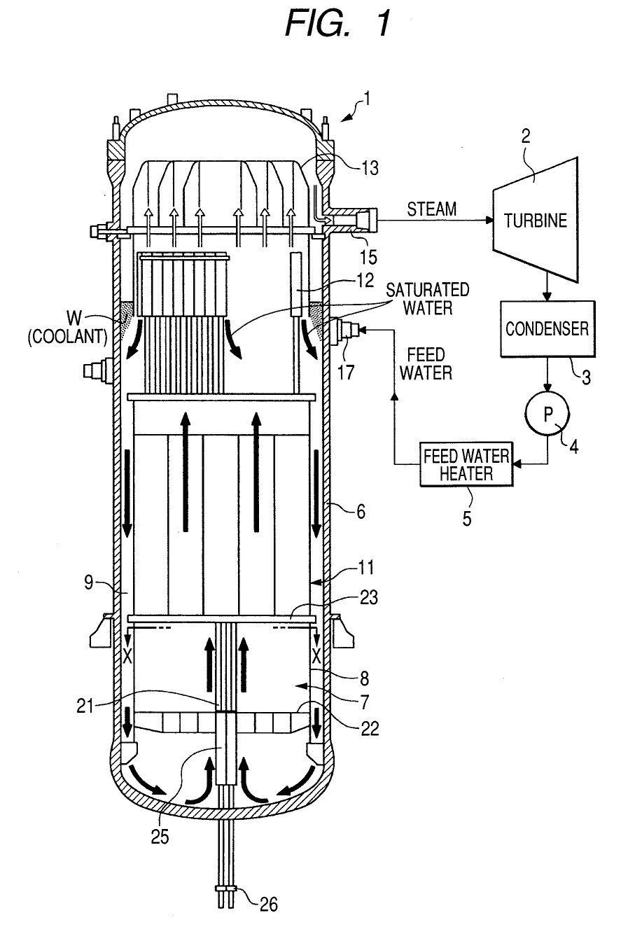

FIG. 1 shows a structure of a natural circulation boiling water reactor (referred to as reactor hereinafter) of first embodiment of the present invention. A reactor 1 includes a reactor pressure vessel (referred to as pressure vessel hereinafter) 6, a core 7, a cylindrical core shroud 8, a core plate 22, an upper lattice plate 23, a cylindrical chimney 11, a steam separator 12 and a steam dryer 13. The core 7, the core shroud 8, the core plate 22, the upper lattice plate 23, the chimney 11, the steam separator 12 and the steam dryer 13, as in-reactor structure are disposed in the pressure vessel 6. A plurality of fuel assemblies 21 are loaded in the core 7. The core shroud 8 encloses an outer periphery of the core 7. The upper lattice plate 23 is placed above the core 7. The cylindrical chimney 11 is installed upright on the upper lattice plate 23. The steam separator 12 with standpipes is mounted on the chimney 11 and covers an upper end of the chimney 11. The steam dryer 13 has a skirt section and is mounted above the steam separator 12 so as to enclose the steam separator 12 by a lower portion of the skirt section. A steam outlet nozzle 15 and a feed water inlet nozzle 17 are provided to the pressure vessel 6.

In the core 7, a plurality of fuel assemblies 21 are loaded at equal intervals between the core plate 22 and upper lattice plate 23. Control rods (not shown) are arranged in the core 7 in one out of four fuel assemblies 21 so they can slide freely. A plurality of control rod drive mechanisms 26 are provided to a lower portion of the pressure vessel 6 and disposed the outside of the pressure vessel 6 and a plurality of control rod guide tubes 25 are disposed under the core 7. The control rod is operated vertically through the control rod guide tube 25 by the control rod drive mechanism 26, and thereby reactor power is controlled.

Furthermore light water which is the coolant W is filled into the pressure vessel 6 to midway of the height of the steam separator 12. When the reactor 1 is operated, the coolant W is exposed to the heat generated in the core 7 by nuclear reaction induced by the nuclear fuel stored in the fuel assemblies 21. The coolant W heated by this heat becomes a gas-liquid two-phase flow including steam and water. Thus, because the specific gravity of the coolant W becomes light, the coolant W ascends naturally.

After the coolant W in gas-liquid two-phase state ascends in the chimney 11, the coolant W in the gas-liquid two-phase state separates into saturated water and steam when it passes the steam separator. This separated and saturated water is introduced to the downcomer 9 which is a vertical flow path between an inner surface of the pressure vessel 6, and the core shroud 8 and the chimney 11 and flows downwards.

On the other hand, the steam separated at the steam separator 12 is further introduced to the steam dryer 13 in order to remove moisture being included in the steam. After a sufficient quantity of moisture has been removed by the steam dryer 13, the steam is discharged from the steam outlet nozzle 15 and is supplied to the turbine 2 that converts the steam into drive energy. It is to be noted that in some cases the steam separator 12 is not provided and moisture is separated only by the steam dryer 13.

The steam, after driving the turbine 2, is condensed at the condenser 3 and reconverted to water (feed water). Then the water is pressurized by the feed pump 4 and flows as feed water through the feed water heater 5 via the feed water inlet nozzle 17 into the pressure vessel 6. The feed water and the saturated water mix to become the coolant W again in the pressure vessel 6.

Because the temperature of the feed water is lower than that of the saturated water, when proportion of feed water in core flow rate of the coolant W becomes high, the temperature of the coolant W becomes low and thermal margin is increased effectively. However, flow rate of the feed water is determined by the reactor power and is a fixed amount that does not depend on the core flow rate of the coolant W. Thus, when the core flow rate of the coolant W increases, the phenomenon occurs whereby the proportion of saturated water in the coolant W increases and the temperature of the coolant W increase. Accordingly, when the core flow rate of the coolant W is set, the relationship between flow rate and temperature of the coolant W must be considered.

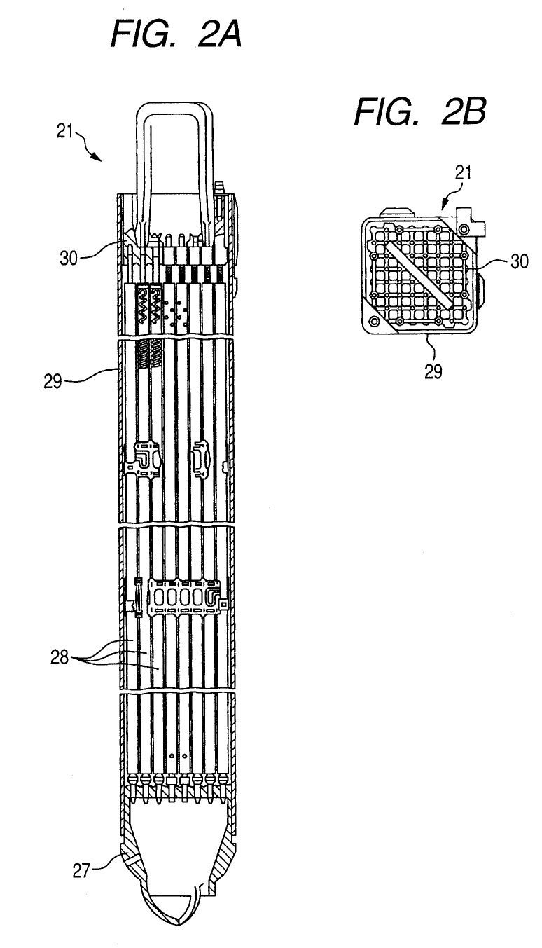

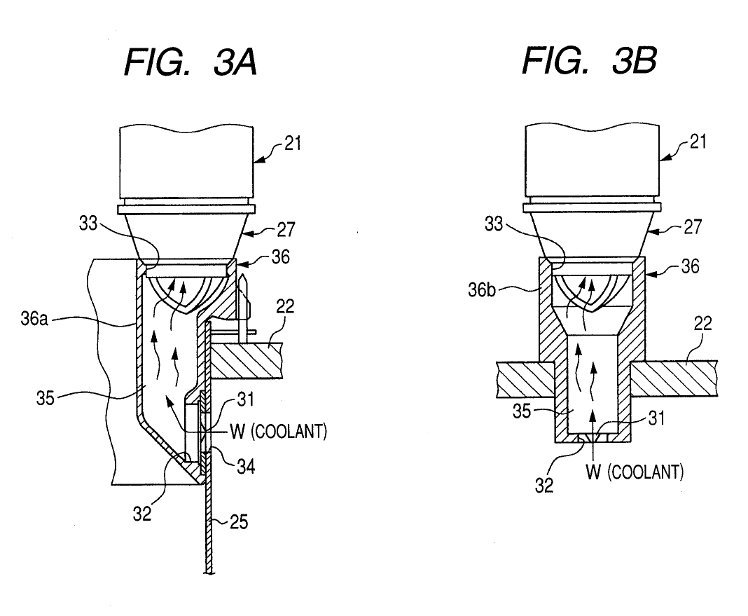

FIG. 2A shows a longitudinal section of the fuel assembly, and FIG. 2B is a plane view of the fuel assembly viewed from above. The fuel assembly 21 has a plurality of fuel rods 28 (FIG. 2A shows the aspect with 8×8=64) fixed between the lower tie plate 27 and the upper tie plate 30. A channel box 29 encloses a fuel bundle having the plurality of fuel rods 29. The periphery of the fuel assembly forms a substantially square cylinder by the channel box 29. The lower tie plate 27 of the fuel assembly 21 is inserted in the fuel support (see FIGS. 3A and 3B) 36 and the fuel assemblies 21 are placed in the core 7. The fuel support 36 is fixed on the core plate 22. The lower portion of the fuel support 36 is inserted in upper end portion of the control rod guide tube 25.

FIG. 3A and FIG. 3B show a method for placing the fuel assembly on the fuel support 36, the fuel support and control rod guide tube on the core plate. It is to be noted that because there are differences from a method for installing the fuel support 36 in an inner region of the core 7 and another method for installing the fuel support 36 in an outermost region of the core 7, FIG. 3A shows the former method and FIG. 3B shows the latter method.

The fuel support 36 has four hollows in which flow path 35 for the coolant W is formed respectively. An upper penetration hole 33 is formed at an upper portion of the hollow. The lower tie plate 27 of the fuel assembly 21 is fit into the upper penetration hole 33. four coolant flow inlets 32 are provided at the lower portion of the fuel support 36. The coolant W flows into the flow path 35 from the coolant flow inlet 32, and then is taken in at the fuel assembly 21.

As shown in FIG. 3A, in the inner region, the control rod guide tube 25 is fixed to the core plate 22, and the fuel support 36a in the inner region is fixed to the upper portion of the control rod guide tube 25. When the fuel support 36a in the inner region is fixed to the control rod guide tube 25, a penetration hole 34 is formed in the control rod guide tube 25 at the same position as the coolant flow inlet 32. The orifice 31 is placed at the front surface of the coolant flow inlet 32.

The coolant W flow in the flow path 35 of the fuel support 36a in the inner region, from the penetration hole 34 via the orifice 31 and the coolant flow inlet 32, and is taken into the fuel assembly 21. The flow rate of the coolant W that is taken into the fuel support 36a is set according to the pressure loss coefficient of the orifice 31.

That is to say, if an opening diameter of the orifice 31 is made larger, the pressure loss in across the orifice becomes small and thus the flow rate of the coolant W passing through the orifice 31 is increased. On other hand, if the opening diameter of the orifice 31 is made smaller, the pressure loss across the orifice becomes large and thus the flow rate of the coolant W passing through the orifice 31 is reduced. Thus, if the flow rate of the coolant W to the fuel support 36a in the inner region is to be increased, the opening diameter of the orifice 31 is made larger, or in other words, the pressure loss coefficient is set to be small. if the flow rate of the coolant W to the fuel support 36a in the inner region is to be decreased, the opening diameter of the orifice 31 is made smaller, or in other words, the pressure loss coefficient is set to be large.

As shown in FIG. 3B, because there control rods (not shown) are not placed in the outermost region, a fuel support 36b in the outermost region is directly fixed to the core plate 22. Furthermore, the orifice 31 is directly fixed to the coolant flow inlet 32 at the bottom surface of the fuel support 36b in the outermost region. The coolant W flows through the flow path 35 of the fuel support 36b in the outermost region via the orifice 31 and is then taken in the fuel assembly 21. Setting of the flow rate of the coolant W that is taken into the fuel support 36b in the outermost region by the pressure loss coefficient of the orifice 31 is the same as for the inner region.

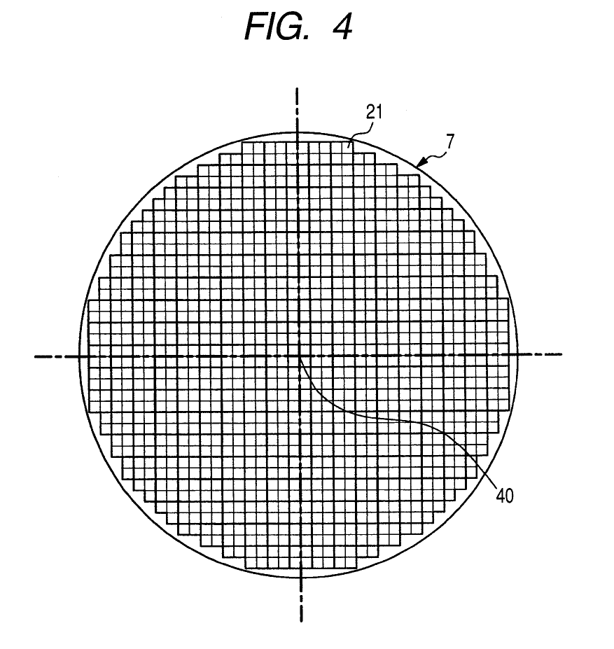

FIG. 4 is the cross-section of FIG. 1 along a line X-X, and shows the core loading the fuel assembly. It is to be noted one of the grids indicated in FIG. 4 shows one fuel assembly 21. As shown in the drawing, the fuel assembly 21 is loaded in the core plane center 40 in a substantially cylindrical shape.

### First Embodiment

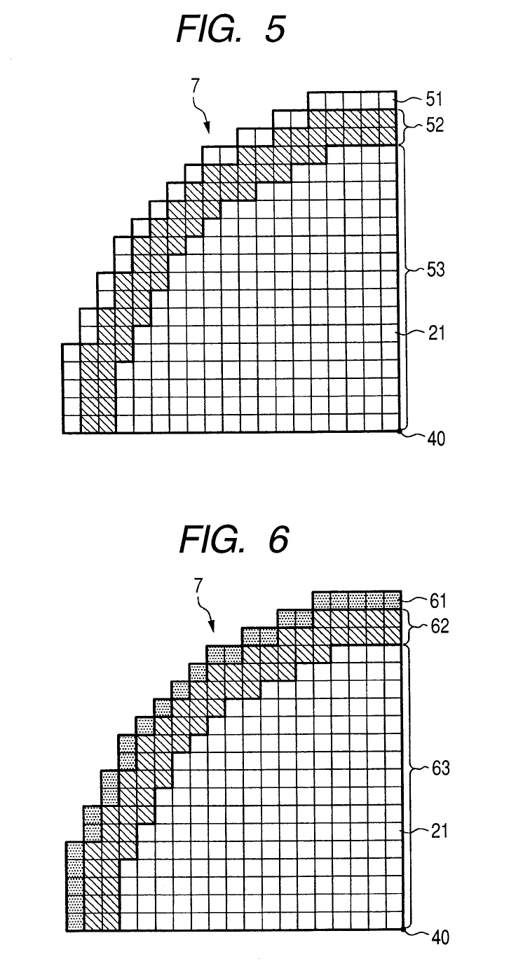

The following is a description of the first embodiment of the present invention. FIG. 5 shows the fuel assemblies loaded in the core in only the region which is the upper left quarter shown in FIG. 4. The region not shown in FIG. 5 can be considered to be a figure in which the region in FIG. 5 is rotated 90°, 180°, and 270° clockwise around the core plane center 40 and thus for simplification, a quarter of the diagram is described.

As shown in FIG. 5, in the first embodiment, the core 7 is divided into three regions in a radial direction. That is to say, the core 7 is divided into three regions including one layer (referred to as an outermost region hereinafter) 51 at the outermost side of the core 7, two-three layers (referred to as an outer region hereinafter) 52 inside the outermost region 51 and other layers (referred to as an inner region hereinafter) 53 inside the outer region 52. The outermost region 51 is first region, the outer region 52 is second region and the inner region 53 is third region. It is to be noted that in the first embodiment, the outermost region 51 is a most outside layer and the outer region 52 is two-three layers inside the outermost region 51, but the number of layers in each region is not limited by this embodiment and may be set as necessary.

The orifice pressure loss coefficients in the same region are all set to be equal.

Furthermore, the relationship between the core flow rate of the coolant W and the temperature of the coolant W as well as the degree of effect on reactivity in the core is considered in setting the orifice pressure loss coefficient for each of the outermost region 51, outer region 52, and the inner region 53.

First, for the outer region 52, the flow rate of the coolant W is set for each fuel assembly 21. Generally, the power of the fuel assembly 21 in the outer region 52 is lower than that of the fuel assembly 21 in the inner region 53. However, the effect on reactivity of the outer region 52 for the entire core 7 is larger than that of the outermost region 51. As a result, increasing the flow rate of the coolant W for each fuel assembly 21 in the outer region 52 and increasing the power of the fuel assembly 21 is effective. Thus it is preferable that for the outer region 52, the orifice pressure loss coefficient is set to be smaller than the inner region 53, in order to increase the flow rate of the coolant W for each fuel assembly 21 to the outer region 52.

Next, for the outermost region 51, the flow rate of the coolant W is set for each fuel assembly 21. In this region, as is the case for the outer region 52, the power of the fuel assembly 21 is lower than that of the fuel assembly 21 in the inner region 53. However, because the outermost region 51 is a region in which fuel assemblies in which burnup has progressed are loaded, and because there is leakage of neutrons to the outside of the core, the effect of reactivity of the outermost region 51 for the entire core 7 is smaller than for the inner region 53. Thus, decreasing the core flow rate of the coolant W for each fuel assembly 21 in outermost region 51 and reducing the core flow rate of the coolant W are effective. As a result, it is preferable that for the outermost region 51, the orifice pressure loss coefficient is set to be larger than the outer region 52, in order to reduce the flow rate of the coolant W for each fuel assembly 21.

That is to say, showing size relationship for the orifice pressure loss coefficients of each region in the first embodiment as a pattern gives the following:

Orifice Pressure Loss Coefficient

Outer region 52<outermost region 51

Outer region 52<inner region 53

It is to be noted that in the first embodiment, this size relationship does not apply to the orifice pressure loss coefficient of the outermost region 51 and the inner region 53.

In the first embodiment, the orifice pressure loss coefficient of the outermost region 51 is set to be equal to that of the inner region 53 and the orifice pressure loss coefficient of the outer region 52 is set to approximately 0.05 times that of the inner region 53 based on the setting of the orifice pressure loss coefficient above. Consequently, the effects of a 2% reduction in power peaking, and also a 3% increase in the thermal margin, and a 0.1% increase in reactivity at operation cycle end can be confirmed. These values indicate that the core power distribution is flattened even more and thermal margin and reactivity are improved.

### Second Embodiment

The following is a description of the second embodiment of the present invention. FIG. 6 shows the fuel assemblies loaded in the core in only the region which is the upper left quarter shown in FIG. 4. It is to be noted that the method for viewing the diagram is the same as in the first embodiment and thus a description thereof has been omitted.

As shown in FIG. 6, in the second embodiment, the core 7 is divided into three regions in a radial direction. That is to say, the core 7 divided into three regions including one layer (outermost region) 61 at the outermost side of the core 7, two-three layers (outer region) 62 inside the outermost region 61, and other layers (inner region) 63 inside the outer region 62. The outermost region 61 is first region, the outer region 62 is second region and the inner region 63 is third region. It is to be noted that as is the case in the first embodiment, the number of layers in each region is not limited by that shown in the drawing and may be set as necessary.

The orifice pressure loss coefficients in the same region are all set to be equal.

Furthermore, the relationship between the core flow rate of the coolant W and the temperature of the coolant W as well as reactivity in the core is considered in setting the orifice pressure loss coefficient for each of the outermost region 61, outer region 62, and the inner region 63.

First, for the outer region 62, the flow rate of the coolant W is set for each fuel assembly 21. For the same reason as in the first embodiment, it is preferable that for the outer region 62, the orifice pressure loss coefficient is set to be smaller than for the inner region 63, in order to increase the flow rate of the coolant W for each fuel assembly 21 in the outer region 62.

Next, for the outermost region 61, the flow rate of the coolant W is set for each fuel assembly 21. For the same reason as that of the first embodiment, for this region 61 also, it is preferable that the orifice pressure loss coefficient is set to be larger than that of the outer region 62, in order to reduce the flow rate of the coolant W for each fuel assembly 21 in the outermost region 61.

Furthermore, in the second embodiment, the relationship between the outermost region 61 and the inner region 63 is also considered.

That is to say, as described above, because the effect on core reactivity of the outermost region 61 can be considered to be small, the flow rate of the outermost region 61 is set so as to be small in order to reduce core flow rate of the coolant W and increase the thermal margin more. Thus, for the outermost region 61, it is preferable that the orifice pressure loss coefficient is set to be larger than that of the inner region 63, in order to reduce the flow rate of the coolant W for each fuel assembly 21.

That is to say, showing size relationship for the orifice pressure loss coefficients in the second embodiment as a pattern gives the following:

Orifice Pressure Loss Coefficient

Outer region 62<inner region 63<outermost region 61

In the second embodiment, when the orifice pressure loss coefficient for the outermost region 61 is set to be approximately 6 times of that of the inner region 63 and the orifice pressure loss coefficient of the outer region 62 is set to approximately 0.05 times of that of the inner region 63 based on the setting of the orifice pressure loss coefficient above, favorable effects which exceed that of the first embodiment are obtained in terms of even reactor power distribution and improvement in thermal margin and reactivity.

### Third Embodiment

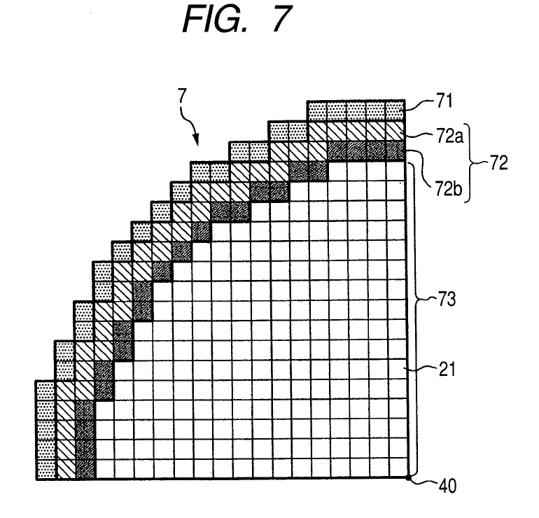

The following is a description of the third embodiment of the present invention. FIG. 7 shows the fuel assemblies loaded in the core in only the region which is the upper left quarter shown in FIG. 4. It is to be noted that the method for viewing the diagram is the same as in the first embodiment and thus a description thereof has been omitted.

As shown in FIG. 7, in the third embodiment, the core 7 is divided into three regions in a radial direction. That is to say, the core 7 is divided into three regions including one layer (outermost region) 71 at the outermost side of the core 7, two-three layers (outer region) 72 inside the outermost region 71 and other layers (inner region) 73 inside the outer region 72. The outermost region 71 is first region, the outer region 72 is second region and the inner region 73 is third region. It is to be noted that as is the case in the first embodiment, the number of layers in each region is not limited by that shown in the drawing and may be set as necessary.

Furthermore, as shown in FIG. 7, in the third embodiment, the outer region 72 is divided into two regions which are the outer region 72a within the outer region 72 and inner region 72b within the outer region 72. That is to say, in the third embodiment, the core 7 is divided into four regions.

It is to be noted that in FIG. 7, one outer layer of the two layers in outer region 72 is the outer region 72a and the remaining one-two layers form the inner region 72b. However, a number of layers in each region is not limited to that shown in the drawing, and may be set in accordance with the number of layers in the outer region 72 as necessary.

The orifice pressure loss coefficients in the same region are all set to be equal.

Furthermore, the relationship between the core flow rate of the coolant W and the temperature of the coolant W as well as reactivity in the core is considered in setting the orifice pressure loss coefficient for each of the outermost region 71, outer region 72a, inner region 72b and the inner region 73.

For the outer region 72, the flow rate of the coolant W is set for each fuel assembly 21, and for the same reason as in the first embodiment, it is preferable that the flow rate of coolant W for each fuel assembly 21 is set so as to be greater than that of the inner region 73.

According to this embodiment, the outer region 72 includes the outer region 72a and the inner region 72b, and thus the flow rate of the coolant W for each fuel assembly 21 in these regions are individually set. Because the outer region 72a and the inner region 72b are both regions within the outer region 72, the flow rate of the coolant W for each fuel assembly 21 in the regions 72a and 72b is made larger than that of the inner region 73. Also, in the positional relationship between the outer region 72a and the inner region 72b, because the outer region 72a is positioned closer to the outside, in the outer region 72a, power of the fuel assembly 21 that is higher than in the inner region 72b is required. Therefore, the outer region 72a must have more flow rate of the coolant W for each fuel assembly 21. In order to realize this flow rate distribution of the coolant W, the orifice pressure loss coefficient for the outer region 72a is set to be smaller than the orifice pressure loss coefficient for the inner region 72b.

Next, for the outer region 71, the flow rate of the coolant W is set for each fuel assembly 21. In this region, for the same reason as in the second embodiment, it is preferable that the orifice pressure loss coefficient is set to be larger than the inner region 73, in order to reduce the flow rate of the coolant W for each fuel assembly 21 in the outermost region 71.

That is to say, showing size relationship for the orifice pressure loss coefficients in the third embodiment as a pattern gives the following:

Orifice Pressure Loss Coefficient

Outer region 72a<inner region 72b<inner region 73<outermost region 71

### Fourth Embodiment

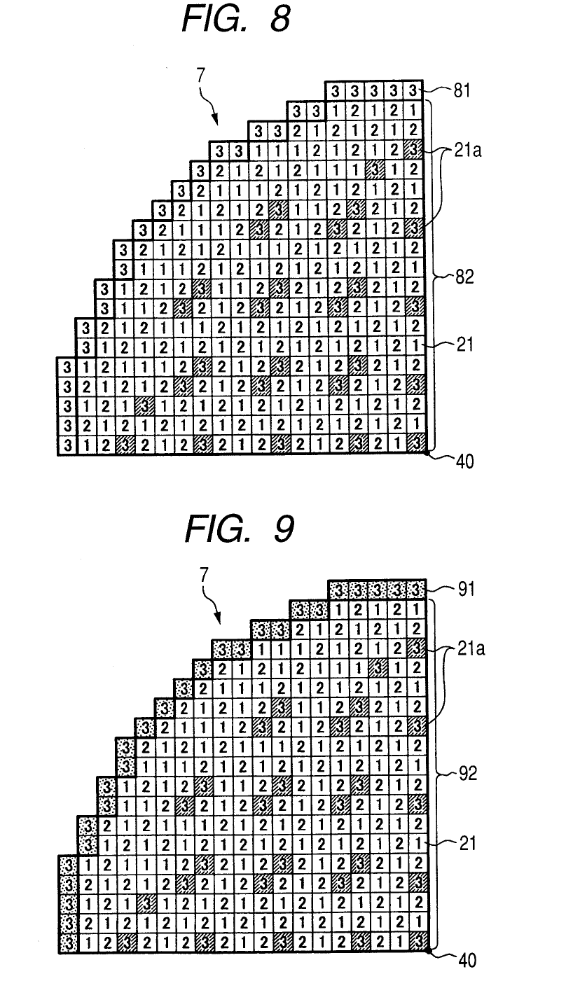

The following is a description of the fourth embodiment of the present invention which gives consideration to the in-core fuel dwelling time of the fuel assembly 21 in the core 7. FIG. 8 shows the fuel assemblies loaded in the core in only the region which is the upper left quarter shown in FIG. 4. It is to be noted that the method for viewing the diagram is the same as in the first embodiment and thus a description thereof has been omitted.

In the fourth embodiment, as shown in FIG. 8, the core 7 is first divided into two regions in a radial direction. That is to say, the core 7 is divided into two regions in a substantially concentric circle including one layer (outermost region) 81 at the outermost side of the core 7 and other layers (inner region) 82 inside the outermost region 81. The outermost region 81 is fourth region and the inner region 82 is fifth region. It is to be noted that in the fourth embodiment, one outermost region forms the outermost region 81, but the number of layers is not limited by that shown in the drawing and may be set as necessary.

Furthermore, in the fourth embodiment, a region (called long dwelling region A hereinafter) formed by collecting the fuel assemblies 21a which have long in-core fuel dwelling time in the core among the fuel assemblies 21 loaded in the inner region 82 is the sixth region. That is to say, in the fourth embodiment, the core 7 is divided into three regions.

Thus in the fourth embodiment, the in-core fuel dwelling time of the fuel assemblies 21 is classified into three levels which, starting with the shortest in-core fuel dwelling time are, dwelling cycle 1 (shown by 1 in FIG. 8), dwelling cycle 2 (shown by 2 in FIG. 8), and dwelling cycle 3 (shown by 3 in FIG. 8). The fuel assembly 21 in dwelling cycle 3 is defined as the fuel assembly 21a of long in-core fuel dwelling time. It is to be noted that in the fourth embodiment, the dwelling cycles are divided into three levels, but they may be divided into smaller cycles as necessary. The fuel assembly 21 in dwelling cycle 3 is defined as the fuel assembly 21a of long in-core fuel dwelling time. The embodiment is not to be limited by this, and the fuel assembly 21 in a dwelling cycle suitably selected as necessary may be defined as the fuel assembly 21a of long in-core fuel dwelling time.

The orifice pressure loss coefficients in the same region are all set to be equal.

Furthermore, the relationship between the core flow rate of the coolant W and the temperature of the coolant W as well as the degree of effect on reactivity in the core is considered in setting the orifice pressure loss coefficient for each of the outermost region 81, inner region 82, and the long dwelling region A.

First for the long dwelling region A, the flow rate of the coolant W is set for each fuel assembly 21a. Because the long dwelling region A is region in which the fuel assemblies 21a of the long in-core fuel dwelling time are collected, it is a fuel assembly 21 in which burnup has progressed and the power of the fuel assembly 21a is small. Therefore, it is preferable that flow rate of the coolant W for each fuel assembly 21a in the long dwelling region A is increased, so the power of the fuel assemblies 21a is increased. Thus it is preferable that for the long dwelling region A, the orifice pressure loss coefficient is set to be smaller than for the outermost region 81 and the inner region 82, in order to increase the flow rate of the coolant W for each fuel assembly 21a of long in-core fuel dwelling time.

That is to say, showing size relationship for the orifice pressure loss coefficients in the fourth embodiment as a pattern gives the following:

Orifice Pressure Loss Coefficient

Long dwelling region A<outermost region 81

Long dwelling region A<inner region 82

It is to be noted that in the fourth embodiment, this size relationship does not apply to the orifice pressure loss coefficient of the outermost region 81 and the inner region 82.

### Fifth Embodiment

The following is a description of the fifth embodiment of the present invention giving consideration to the in-core fuel dwelling time of the fuel assembly 21 in the core 7. FIG. 9 shows the fuel assemblies loaded in the core in only the region which is the upper left quarter shown in FIG. 4. It is to be noted that the method for viewing the diagram is the same as in the first embodiment and thus a description thereof has been omitted.

In the fifth embodiment, as shown in FIG. 9, the core 7 is first divided into two regions in a radial direction. That is to say, the core 7 is divided substantially concentrically into two regions including one layer (outermost region) 91 at the outermost side of the core 7 and other layers (inner region) 92 inside the outermost region 91. The outermost region 91 is fourth region and the inner region 92 is fifth region. It is to be noted that in the fifth embodiment, one outermost region forms the outermost region 91, but the number of layers is not limited by this embodiment and may be set as necessary.

Furthermore, in the fifth embodiment, a region (called long residence region B hereinafter) formed by collecting the fuel assembly 21a of the long in-core fuel dwelling time among the fuel assemblies 21 loaded in the inner region 92 is the sixth region. That is to say, in the fifth embodiment, the core 7 is divided into three regions.

The classifications of the in-core fuel dwelling time of the fuel assembly 21 and the definition of the fuel assembly 21a of the long in-core fuel dwelling time in this fifth embodiment are the same as those for the fourth embodiment and thus descriptions thereof will be omitted.

The orifice pressure loss coefficients in the same region are all set to be equal.

Furthermore, the relationship between the core flow rate of the coolant W and the temperature of the coolant W as well as the degree of effect on reactivity in the core is considered in setting the orifice pressure loss coefficient for each of the outermost region 91, inner region 92, and the long dwelling region B.

For the long dwelling region B, for the same reason as in the fourth embodiment, it is preferable that the orifice pressure loss coefficient is set to be smaller than the outermost region 91 and the inner region 92, in order to increase the flow rate of the coolant W for each fuel assembly 21a of long in-core fuel dwelling time.

For the outermost region 91, the flow rate of the coolant W is set for each fuel assembly 21a. In this region 91, as shown in FIG. 9, the fuel assemblies 21a of long in-core fuel dwelling time are loaded. However, because the outermost region 91 is a most outside layer region and also there is the effect leakage of neutrons to the outside of the core, the effect on reactivity of the outermost region 92 91 for the entire core 7 is small. Thus, decreasing the flow rate of the coolant W for each fuel assembly 21 in outermost region 91 and reducing the core flow rate of the coolant W is preferable. As a result, it is preferable that for the outermost region 91, the orifice pressure loss coefficient is set to be larger than that for the inner region 92 in order to reduce the flow rate of the coolant W for each fuel assembly 21.

That is to say, showing size relationship for the orifice pressure loss coefficients in the fifth embodiment as a pattern gives the following:

Orifice Pressure Loss Coefficient

Long dwelling region B<inner region 92<outermost region 91

### Sixth Embodiment

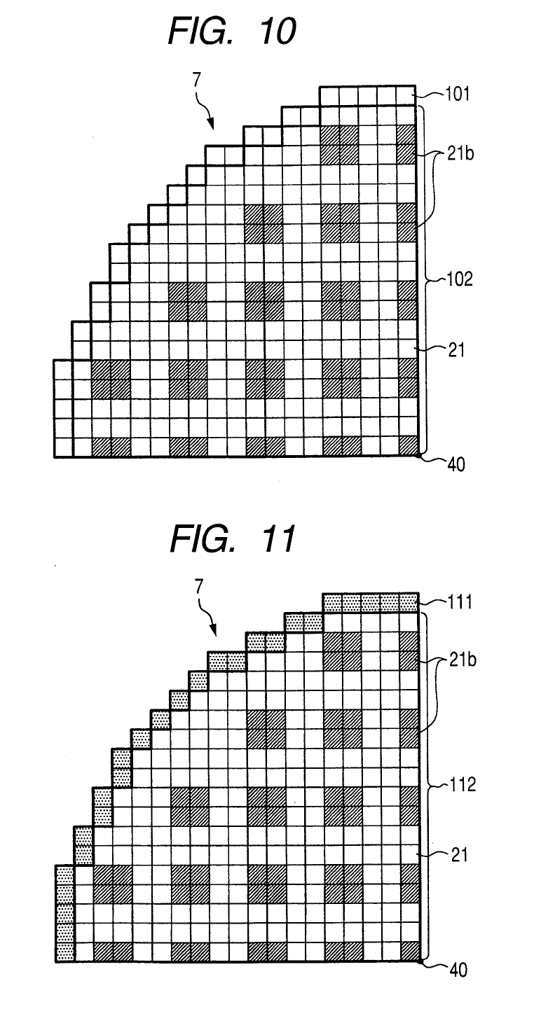

The following is a description of the sixth embodiment of the present invention using a control cell. In the reactor 1, excess reactivity and the reactor power distribution are controlled using controls rods (not shown) at specified positions during operation cycle. The four fuel assemblies arranged around one control rod at the specified positions are called the control cell. FIG. 10 shows the fuel assemblies loaded in the core in only the region which is the upper left quarter shown in FIG. 4. It is to be noted that the method for viewing the diagram is the same as in the first embodiment and thus a description thereof has been omitted.

The sixth embodiment is used in the core reactor 7 which uses the control cell. As shown in FIG. 10, the core 7 is divided into two regions in a radial direction. That is to say, the core 7 is divided substantially concentrically into two regions including one layer (outermost region) 101 at the outermost side of the core 7 and other layers (inner region) 102 inside the outermost region 101. The outermost region 101 is seventh region and the inner region 102 is eighth region. It is to be noted that in the sixth embodiment, one outermost region forms the outermost region 101, but the number of layers is not limited by this embodiment and may be set as necessary.

Furthermore, in the sixth embodiment, a region (called control region A hereinafter) formed by collecting the fuel assemblies 21b in the control cell among the fuel assemblies 21 loaded in the inner region 102 is the ninth region described in the claims. That is to say, in the sixth embodiment, the core 7 is divided into three regions.

The orifice pressure loss coefficients in the same region are all set to be equal.

Furthermore, the relationship between the core flow rate of the coolant W and the temperature of the coolant W as well as the degree of effect on reactivity in the core is considered in setting the orifice pressure loss coefficient for each of the outermost region 101, inner region 102, and the control region A.

For the control region A, the flow rate of the coolant W is set for each fuel assembly 21b. The control region A is disposing the fuel assemblies 21b in the control cell. Because the fuel assemblies 21 in which burnup has progressed, that is, the fuel assemblies 21b in which the in-core fuel dwelling time is long are loaded in the control cell, the power of the fuel assemblies 21b in the control region A is small. Therefore, it is preferable that flow rate of the coolant W for each fuel assembly 21b in the control region A is increased and power of the fuel assembly 21b is increased. Thus it is preferable that for the control region A, the orifice pressure loss coefficient is set to be smaller than for the outermost region 101 and the inner region 102, in order to increase the flow rate of the coolant W for each fuel assembly 21b in the control cell.

That is to say, showing size relationship for the orifice pressure loss coefficients in the sixth embodiment as a pattern gives the following:

Orifice Pressure Loss Coefficient

Control region A<outermost region 101

Control region A<inner region 102

It is to be noted that in the sixth embodiment, this size relationship does not apply to the orifice pressure loss coefficient of the outermost region 101 and the inner region 102.

### Seventh Embodiment

The following is a description of the sixth embodiment of the present invention using a control cell. FIG. 11 shows the fuel assemblies loaded in the core in only the region which is the upper left quarter shown in FIG. 4. It is to be noted that the method for viewing the diagram is the same as in the first embodiment and thus a description thereof has been omitted.

As is the case in the sixth embodiment, the seventh embodiment also is used in the core reactor 7 which uses the control cell. As shown in FIG. 11, the core 7 is first divided into two regions in a radial direction. That is to say, the core 7 is divided substantially concentrically into two regions including one layer (outermost region) 111 at the outermost side of the core 7 and other layers (inner region) 112 inside the outermost region 111. The outermost region 111 is seventh region and the inner region 112 is eighth region. It is to be noted that in the seventh embodiment, the outermost region 111 is formed by a most outside layer, but the number of layers is not limited by this embodiment and may be set as necessary.

Furthermore, in the seventh embodiment, a region (called control region B hereinafter) formed by collecting the fuel assemblies 21b in the control cell among the fuel assemblies 21 loaded in the inner region 112 is the ninth region. That is to say, in the seventh embodiment, the core 7 is divided into three regions.

The orifice pressure loss coefficients in the same region are all set to be equal.

Furthermore, the relationship between the core flow rate of the coolant W and the temperature of the coolant W as well as the degree of effect on reactivity in the core is considered in setting the orifice pressure loss coefficient for each of the outermost region 111, inner region 112, and the control region B.

For the control region B, for the same reason as in the sixth embodiment, the orifice pressure loss coefficient is set to be smaller than for the outermost region 111 and the inner region 112, in order to increase the flow rate of the coolant W for each fuel assembly 21b in the control cell.

For the outermost region 111, the flow rate of the coolant W is set for each fuel assembly 21. In this region 111, the power of the fuel assembly 21 is lower than that of the fuel assembly 21 in the inner region 112. As described above, because the outermost region 111 is a region in which fuel assemblies 21 in which burnup has progressed, that is, the fuel assemblies 21b in which the in-core fuel dwelling time is long are loaded and also there is leakage of neutrons to the outside of the core, the effect of reactivity of the outermost region 111 for the entire core 7 is smaller than for the inner region 112. Thus, for the outermost region 111, decreasing the flow rate of the coolant W for each fuel assembly 21 and reducing the flow rate of the coolant W is effective. As a result, it is preferable that for the outermost region 111, the orifice pressure loss coefficient is set to be larger than for the inner region 112, in order to reduce the flow rate of the coolant W for each fuel assembly 21.

That is to say, showing size relationship for the orifice pressure loss coefficients of each region the seventh embodiment as a pattern gives the following:

Orifice Pressure Loss Coefficient

Control region B<inner region 112<outermost region 111

### Other Embodiments

The first embodiment to the seventh embodiment have been described above, but the embodiments of the present invention are not limited to the content described above, and other embodiments may be considered.

For example, the second embodiment and the fourth embodiment may be combined. In this case, the orifice pressure loss coefficient is set at four regions which, in addition to the outermost region which is the first region, the outer region which is the second region and the inner region which is the third region, include a tenth region in which the fuel assemblies of long in-core fuel dwelling time loaded in the inner region are collected. The orifice pressure loss coefficient for the tenth region may be set to be the same as the other regions or may be set to be different provided that it is optimally set to obtain a favorable thermal margin.

In addition, a combination of the second embodiment and the sixth embodiment or a combination of the third embodiment and the fourth embodiment may be suitably applied.

Furthermore, the inner regions of each embodiment may be further divided concentrically and classified into many regions, and the orifice pressure loss coefficient for each region may be set to have smaller ranges.

What is claimed is:

1. A natural circulation boiling water reactor, comprising:
a reactor pressure vessel;
a core loading a plurality of fuel assemblies and disposed in said reactor pressure vessel; and
a plurality of fuel supports placing in said reactor pressure vessel, for supporting said fuel assembly and forming a coolant flow path in which orifice for adjusting flow rate of coolant is disposed, for introducing said coolant to said fuel assembly,
wherein said core includes an third region, a second region surrounding said third region and an outermost first region surrounding said second region in a radial direction;
pressure loss coefficient for said orifice disposed in said second region is set so as to be smaller than that for said orifice disposed in said third region; and
the pressure loss coefficient for said orifice disposed in said first region is set so as to be larger than the pressure loss coefficient for said orifice disposed in said second region.

2. The natural circulation boiling water reactor according to claim 1,
wherein the pressure loss coefficient for said orifice in said first region is set so as to be larger than the pressure loss coefficient for said orifice in said third region.

3. The natural circulation boiling water reactor according to claim 1,
wherein a number of said orifices is equal to a number of said fuel assemblies, and said orifice is provided to said fuel support.

4. The natural circulation boiling water reactor according to claim 2,
wherein a number of said orifices is equal to a number of said fuel assemblies, and said orifice is provided to said fuel support.

5. A natural circulation boiling water reactor, comprising:
a reactor pressure vessel;
a core loading a plurality of fuel assemblies and disposed in said reactor pressure vessel; and
a plurality of fuel supports placing in said reactor pressure vessel, for supporting said fuel assembly and forming a coolant flow path in which orifice for adjusting flow rate of coolant is disposed, for introducing said coolant to said fuel assembly,
wherein said core includes an fifth region and an outermost fourth region surrounding said fifth region in a radial direction, and a plurality of sixth regions disposed in said fifth region and having said fuel assembly that in-core fuel dwelling time is longer than that of said fuel assembly disposed in said fifth region;
pressure loss coefficient for said orifice in said sixth region is set so as to be smaller than the pressure loss coefficient for of said orifice in said fifth region; and
the pressure loss coefficient for said orifice in said fourth region is set so as to be larger than the pressure loss coefficient for said orifice in said sixth region.

6. The natural circulation boiling water reactor according to claim 5,
wherein the pressure loss coefficient for said orifice in said fourth region is set so as to be larger than the pressure loss coefficient for said orifice in said fifth region.

7. The natural circulation boiling water reactor according to claim 5,
wherein a number of said orifices is equal to a number of said fuel assemblies, and said orifice is provided to said fuel support.

8. The natural circulation boiling water reactor according to claim 6,
wherein a number of said orifices is equal to a number of said fuel assemblies, and said orifice is provided to said fuel support.

9. A natural circulation boiling water reactor, comprising:
a reactor pressure vessel;
a core loading a plurality of fuel assemblies and disposed in said reactor pressure vessel and including a plurality of control cells having a control rod and four fuel assemblies arranged around said control rod; and
a plurality of fuel supports placing in said reactor pressure vessel, for supporting said fuel assembly and forming a coolant flow path in which orifice for adjusting flow rate of coolant is disposed, for introducing said coolant to said fuel assembly,
wherein said core includes an eighth region and an outermost seventh region surrounding said eighth region in a radial direction, and a plurality of ninth regions disposed in said eighth region and having said fuel assembly disposed in said control cell;
pressure loss coefficient for said orifice in said ninth region is set so as to be smaller than the pressure loss coefficient for said orifice in said eighth region; and
the pressure loss coefficient for said orifice in said seventh region is set so as to be larger than the pressure loss coefficient for said orifice in said ninth region.

10. The natural circulation boiling water reactor according to claim 9,
wherein the pressure loss coefficient for said orifice in said seventh region is set so as to be larger than the pressure loss coefficient for said orifice in said eighth region.

11. The natural circulation boiling water reactor according to claim 9,
wherein a number of said orifices is equal to a number of said fuel assemblies, and said orifice is provided to said fuel support.

12. The natural circulation boiling water reactor according to claim 10,
wherein a number of said orifices is equal to a number of said fuel assemblies, and said orifice is provided to said fuel support.
